(19) United States
(12) Patent Application Publication
(10) Pub. No.: US 2015/0225006 A1
(43) Pub. Date: Aug. 13, 2015

(54) Multifunctional Utility Cart

(71) Applicant: Frank William THIEL, Sterling Heights, MI (US)

(72) Inventor: Frank William THIEL, Sterling Heights, MI (US)

(21) Appl. No.: 14/696,673

(22) Filed: Apr. 27, 2015

Related U.S. Application Data
(60) Provisional application No. 62/121,622, filed on Feb. 27, 2015.

(51) Int. Cl. B62B 3/02; B62B 5/04; B62B 5/06

(52) U.S. Cl. CPC B62B 3/02; B62B 5/067; B62B 5/04; B62B 5/061

(57) ABSTRACT

A multifunctional cart is disclosed. The multifunctional cart has a frame and a pair of arms, with the arms extending outward from the frame, and a plurality of platform support members attached to the pair of arms at spaced distances outward from the frame. A platform is slideably engageable between platform support members, providing a height adjustable surface.

### CROSS REFERENCE TO RELATED APPLICATIONS

This application claims the benefit of U.S. Provisional Patent Application No. 62/121,622, filed on Feb. 27, 2015, which is hereby incorporated by reference herein in its entirety.

### FIELD OF THE INVENTION

This invention is directed toward mobile chairs and stools and more specifically to height adjustable mobile chairs with plural operative configurations.

### BACKGROUND

Current multifunctional carts have a frame including an upper and lower support member, with the lower support member fixedly attached to a plurality of wheels and the upper support member attached to a frame member having a pull handle such as disclosed in U.S. Pat. No. 7,661,685. Between the upper and lower support member can be a space used for storage as disclosed in U.S. Pat. No. 6,520,513. Often, the upper support member includes a padded area, with a generally planar seat attached to the frame as disclosed in U.S. Pat. No. 7,891,678. Other height adjustable chairs and stools include U.S. Pat. Nos. 8,569,651, 5,611,511 and 6,010,187.

### SUMMARY

There is a desire to have a multifunctional cart support an ascending or descending force applied by a user using a pair of arms fixedly attached to the frame of the multifunctional cart, acting as a stable arm configuration. Prior devices lack a capability for a stable arm configuration that would allow the user to descend onto the multifunctional cart from a standing position and ascend from the multifunctional cart to the standing position. The stable arm configuration acts to support the ascending or descending force of the user at a height appropriate to a height of the multifunctional cart, with such not provided by the current configurations.

A multifunctional cart can include a frame and a pair of arms, with each arm fixedly attached at opposite ends of the frame and extending outwardly from the frame, thereby defining an outer closed end. The pair of arms support an ascending or descending force applied to the multifunctional cart. A plurality of platform support members can be attached to the frame at spaced distances outwardly from the frame. The platform support members transversely support the pair of arms. A platform can be slideably engageable within an interstitial space, defined as a space between adjacent platform support members, providing an adjustable surface with respect to the frame. Thus the platform support members act to support the ascending or descending force applied to the platform.

A multifunctional cart can include a rectangular frame having a pair of short sides, a pair of long sides, and a pair of arms. Each arm can be fixedly attached at opposite ends of the rectangular frame, extending outwardly from the rectangular frame and defining an outer closed end. The pair of arms support an ascending or descending force applied to the multifunctional cart as the user attempts to rise from a kneeling or seated position. A plurality of platform support members can be transversely attached to the rectangular frame along a longitudinal axis of the rectangular frame at spaced distances outwardly from the rectangular frame. The platform support members transversely support the pair of arms. Further, a platform can be slideably engageable within an interstitial space, defined as a space between adjacent platform support members, providing an adjustable surface with respect to the rectangular frame. The platform can have a pair of stop members fixedly attached to side corner edges of the platform to prevent sliding movement after full engagement of the platform with respect to the platform support members.

A multifunctional cart can include a rectangular frame having a pair of short sides, a pair of long sides, and a pair of arms. Each arm can be fixedly attached at opposite ends of the rectangular frame, extending outwardly from the rectangular frame and defining an outer closed end. The pair of arms support an ascending or descending force applied to the multifunctional cart. A tray can be pivotably attached to the rectangular frame at one of the opposite ends. The tray can be lockable in both a storage position and a use position. A first tray can have a recessed first surface and a second tray can be a cup holder. The multifunctional cart can include a plurality of platform support members transversely attached along a longitudinal axis to the rectangular frame at spaced distances outwardly from the rectangular frame. The platform support members transversely support the pair of arms. A platform can be slideably engageable within an interstitial space, defined as a space between adjacent platform support members, providing an adjustable surface with respect to the rectangular frame. The platform can have a pair of stop member fixedly attached to side corner edges of the platform to prevent sliding movement after full engagement of the platform with respect to the platform support members. The pair of stop members prevent an unintended dislodging movement with respect to the interstitial space between platform support members. The platform can include a first surface with a padded area defining a seat. A pair of side rails can be removably attached to the rectangular frame, defining a storage space.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1A shows a side elevational view of a multifunctional cart showing trays and pull handle in a storage position;

FIG. 1B shows a side elevational view of the multifunctional cart showing the trays and pull handle in an open position;

FIG. 2 shows a plan view of the multifunctional cart showing platform support members;

FIG. 3 shows a perspective view showing engagement of a platform in an interstitial space between the platform support members;

FIG. 4 shows a top plan view showing a second tray and pull handle in the open position;

FIG. 5A shows a top plan view of the multifunctional cart showing the platform with a padded area defining a seat and a pair of arms; and

FIG. 5B shows a bottom plan view of the platform showing pair of stop members.

### DETAILED DESCRIPTION

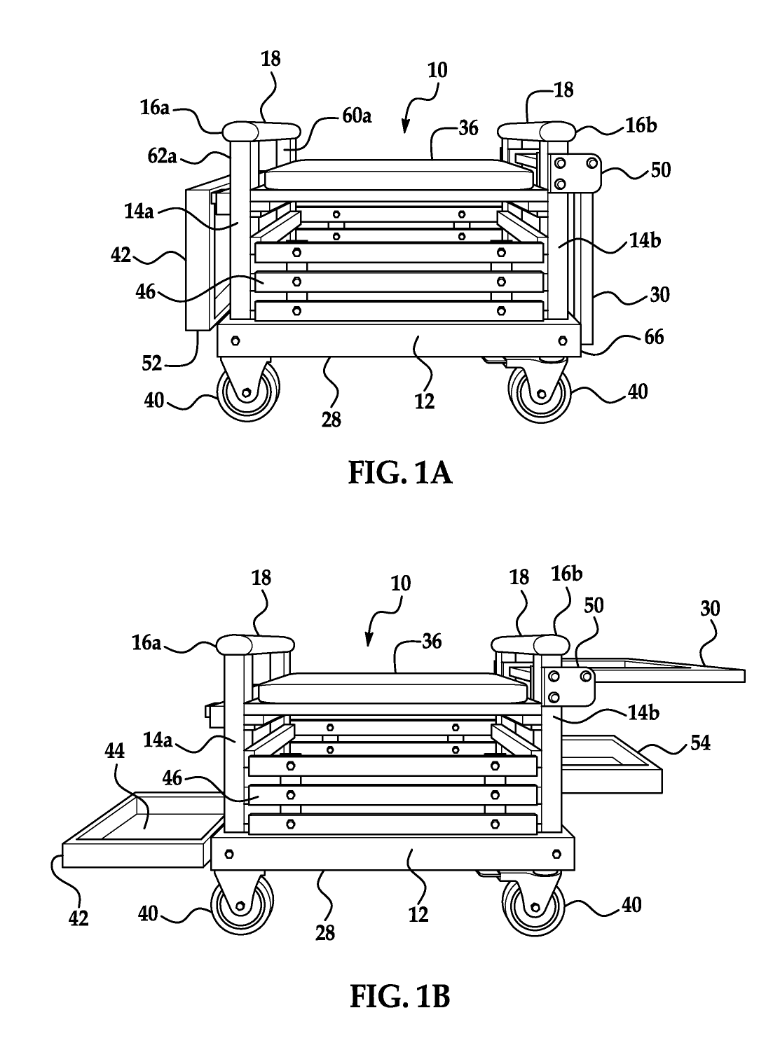

Referring to FIGS. 1A and 1B, a multifunctional cart 10 having a frame 12 forming a structural base 66 of the multifunctional cart 10 is shown. The frame 12 can be fixedly secured at all four corners of the structural base 66. As is known to those skilled in the art, the structural base 66 can be secured by any fastening process, including a plurality of screws, bolts, nails or any combination thereof. Additional processes of fastening can include welding, gluing and the use of dovetailed joints. The frame 12 can support a total load greater than a load associated with a seated, kneeling or laying user, including any load associated with a tray 42, and a load contained within a storage space 48. At opposite ends 16a, 16b of the frame 12, a pair of arms 14a, 14b can be fixedly attached to the frame 12. As is known to those skilled in the art, the pair of arms 14a, 14b can be fixedly attached to the frame 12 by any fastening process, including a plurality of screws, bolts, nails or any combination thereof. Additional processes of fastening can include welding, gluing and the use of dovetailed joints. The pair of arms 14a, 14b can extend outwardly from the frame 12, and terminate in an outer closed end 18a, 18b. The outer closed end 18a, 18b can support an ascending 56 or descending 58 force exerted by the seated, kneeling or laying user. More specifically, the outer closed end 18a, 18b can stabilize the force exerted by the seated, kneeling or laying user, thereby mitigating any uneasiness, difficulty or discomfort associated with ascending or descending onto the multifunctional cart 10.

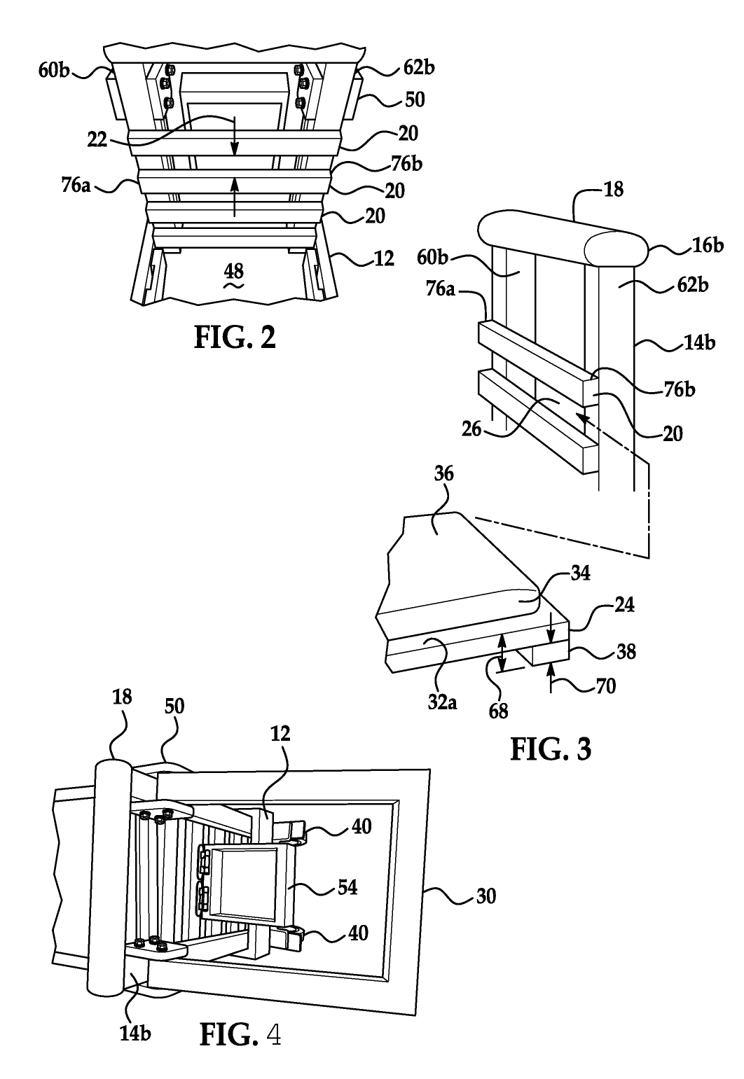

The multifunctional cart 10 further can include a plurality of platform support members 20 fixedly attached to a first arm 60a, 62a and a second arm 60b, 62b of the pair of arms 14a, 14b. As shown in FIG. 2, the platform support members 20 can provide both transverse support between the first arm 60a, 62a and second arm 60b, 62b of the pair of arms 14a, 14b, and support for a platform 24. The number of support members 20 can be any number greater than two, but more preferably between three and five. The number of platform support members 20 is dictated by a desired degree of platform height adjustability and an overall desired height of the multifunctional cart 10. The platform support members 20 can be attached to the pair of arms 14a, 14b at spaced distances 22, with the spaced distances 22 being greater than a total thickness 68 of the platform 24 plus height 70 of a pair of stop members 38.

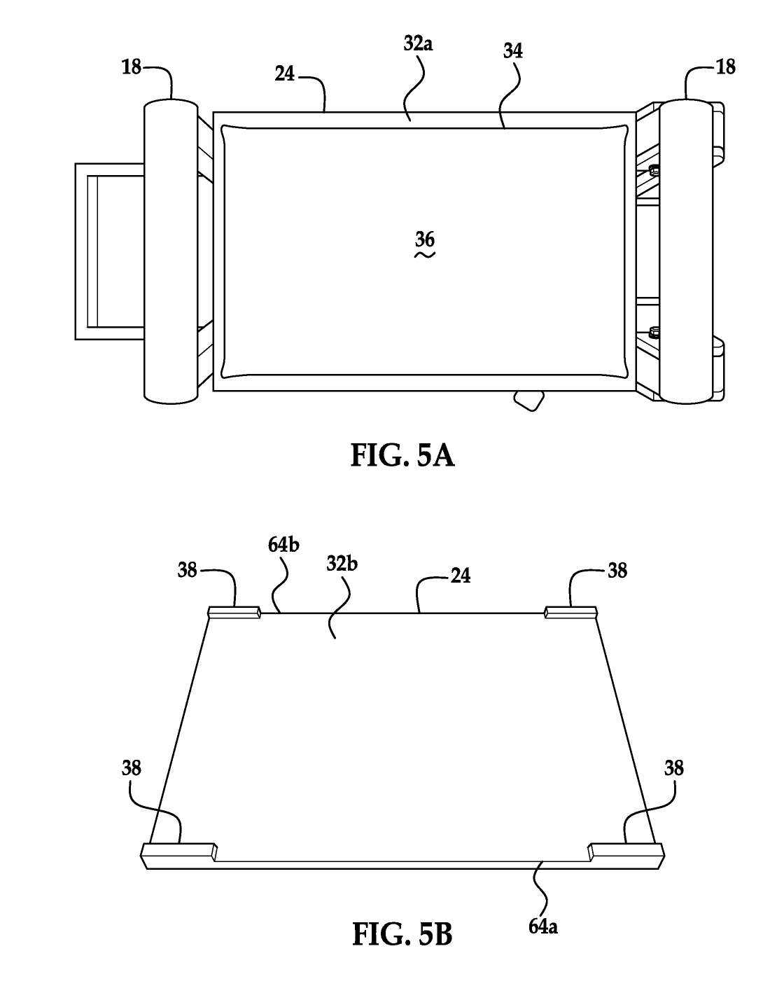

With reference to FIG. 3, the platform 24 can be slideably engageable within an interstitial space 26 between adjacent platform support members 20. More specifically, the interstitial space 26 is a space between adjunct platform support members 20, with the thickness being greater than the total thickness 68 of the platform 24 plus the height 70 of the pair of stop members 38. A secure engagement of the platform 24 in the interstitial space 26 between adjacent platform support members 20 allows for the platform 24 to support the ascending 56, descending 58 and lateral 74 force of the seated, kneeling or laying user. The platform 24 can make secure engagement between any of the adjacent platform support members 20, provided the platform 24 fully engages the interstitial space 26 between adjacent platform support members 20. As shown in FIG. 5B, full engagement of the platform 24 is defined as a state when the pair of stop members 38 make an edgewise engagement with lateral edges 76a, 76b of the platform support members 20.

Referring back to FIGS. 1A and 1B, the multifunctional cart 10 can further include a pull handle 30 attached to at least one of the opposite ends 16a, 16b of the multifunctional cart 10. More specifically, the pull handle 30 can pivotably engage using a hinge bracket 50 to attach to at least one of the pair of arms 14a, 14b. The hinge bracket 50 can be fixably or removably attached to at least one of the pair of arms 14a, 14b. The pull handle 30 can have both a storage position 78 (FIG. 1A) where the pull handle 30 is generally parallel to the pair of frame arms 14a, 14b, and an open position 80 (FIG. 1B and FIG. 4) where the pull handle 30 is generally perpendicular to the pair of frame arms 14a, 14b.

The platform 24 of the multifunctional cart 10 can further include a first surface 32a having a padded area 34 defining a seat 36. The seat 36 can be fixably or removably attached to the platform 24. As known to those skilled in the art, fixable attachment of the seat 36 to the platform 24 can be by any fastening process includes staples, glue, stitching, nails or any combination thereof. As known to those skilled in the art, removable attachment can employ any fastening process including snaps, buttons, fabric hook and loop fastener, or other transient fastening means. The composition and design of the seat 36 as known to those skilled in the art can include a foam or polyurethane cushion surrounded by a weather-resistant vinyl covering. The padded area 34 can occupy any portion of a surface area 72 of the first surface 32a of the platform 24, from a total coverage of the first surface 32a of the platform 24 (see FIG. 5) to the platform 24 having no padded area 34. The only limitation on a size of the padded area 34 is to allow for a secure engagement of the platform 24 in the interstitial space 26 between the platform support members 20.

Referring to FIG. 3 and FIG. 5A, the platform 24 of the multifunctional cart 10 can have a pair of stop members 38. As is known to those skilled in the art, the pair of stop members 38 can be secured to a second surface 32b of the platform 24 at each of the outer edges 64a, 64b by any fastening process, including a plurality of screws, bolts, nails or any combination thereof. Additional processes of fastening can include welding, gluing and the use of dovetailed joints. The pair of stop members 38 acts to prevent lateral movement after full engagement of the platform 24. More specifically, the pair of stop members 38 prevents unintended dislodging movement of the platform 24 by making edgewise engagement with the lateral edges 76a, 76b of the platform support members 20, thereby securing the platform 24 in the interstitial space 26 between platform support members 20.

Referring back to FIG. 1A, the multifunctional cart 10 can further include a plurality of lockable wheels 40 fixedly attached to a bottom surface 28 of the frame 12. The plurality of lockable wheels 40 can be fixedly attached at each of the four corners of the frame 12. As is known to those skilled in the art, the plurality of lockable wheels 40 can be any type of wheel lockable in a stop position. The plurality of lockable wheels 40 can support a total load greater than a load associated with a seated, kneeling or laying user, including any load associated with a tray 42, and a load contained within a storage space 48.

The multifunctional cart 10 can further include a tray 42 attached to at least one of the opposite ends 16a, 16b of the multifunctional cart 10. More specifically, the tray 42 can pivotably engage using a hinge bracket 52 to attach to at least one of the pair of arms 14a, 14b. The hinge bracket 52 can be fixably or removably attached to at least one of the pair of arms 14a, 14b. The tray 42 can have both a storage position 78 (FIG. 1A) where the tray 42 is generally parallel to the pair of frame arms 14a, 14b, and an open position 80 (FIG. 1B and FIG. 4) where the tray 42 is generally perpendicular to the pair of frame arms 14a, 14b. In addition, the multifunctional cart 10 can include a first tray 42a at one of the opposite ends 16a, 16b, where the first tray 42a has a first recessed surface 44. The first tray 42a can contain items as desired by the user, such as but not limited to garden equipment, home improvement tools, paint cans, and automotive tools. Additionally, the multifunctional cart 10 can include a second tray 42b at one of the opposite ends 16a, 16b, where the second tray is a cup holder 54. As known to those skilled in the art, the cup holder 54 can contain a cup, potted plant, can, bottle or alike.

Additionally, the multifunctional cart 10 can include a pair of side rails 46 removably attached to the frame 12. As known to those skilled in the art, the removable attachment can employ any transient joint forming mechanism including but not limited to a bridle joint, dowel joint, finger joint, trench joint, mortise and tenon joint or any combination thereof. Boundaries as defined by the plurality of platform support members 20 transversely attached to the pair of arms 14, and the pair of side rails 46, define a storage space 48. The storage space 48 can contain items as desired by the user, such as but not limited to garden equipment, home improvement tools, and automotive tools.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A multifunctional cart (10) comprising:
a frame (12);
a pair of arms (14), each arm (14) fixedly attached at opposite ends (16) of the frame (12) and extending outwardly from the frame (12) defining an outer closed end (18);
a plurality of platform support members (20) attached to the pair of arms (14) at spaced distances (22) outwardly from the frame (12); and
a platform (24) slideably engageable within an interstitial space (26) between platform support members (20) providing an adjustable surface (32) with respect to the frame (12).

2. The multifunctional cart (10) of claim 1 further comprising:
a pull handle (30) pivotably attached to the frame (12).

3. The multifunctional cart (10) of claim 1, wherein the platform (24) has a first surface (32a) with a padded area (34) defining a seat (36).

4. The multifunctional cart (10) of claim 3, wherein the platform (24) has a pair of stop members (38) fixedly attached to a second surface (32b) at outer edges (64a, b) of the platform (24) to prevent sliding movement after full engagement of the platform (24) with respect to the platform support members (20), preventing an unintended dislodging movement with respect to the interstitial space (26) between the platform support members (20).

5. The multifunctional cart (10) of claim 1 further comprising:
a plurality of lockable wheels (40) attached to the frame (12).

6. The multifunctional cart (10) of claim 1 further comprising:
a tray (42) pivotably attached to the frame (12) at one of the opposite ends (16), wherein the tray (42) is lockable in both a storage position (78) and an open position (80).

7. The multifunctional cart (10) of claim 6, wherein a first tray (42a) has a recessed first surface (44).

8. The multifunctional cart (10) of claim 6, wherein a second tray (42b) is a cup holder (54).

9. The multifunctional cart (10) of claim 1, wherein the frame (12) receives a pair of side rails (46), the side rails (46) removably attached to the frame (12) and defining a storage space (48) therebetween.

10. The multifunctional cart (10) of claim 1, wherein the frame (12), platform (24), pair of arms (14) and platform support members (20) are composed of a lightweight, non-ferrous material.

11. A multifunctional cart (10) comprising:
a rectangular frame (12) having a pair of short sides (82) and a pair of long sides (84);
a pair of side rails (46) removably attached to the rectangular frame (12) and defining a storage space (48);
a pair of arms (14), each arm (14) fixedly attached at opposite ends (16) of the rectangular frame (12) and extending outwardly from the rectangular frame (12) defining an outer closed end (18);
a plurality of platform support members (20) transversely attached along a longitudinal axis (86) to the rectangular frame (12) at spaced distances (22) outwardly from the rectangular frame (12); and
a platform (24) slideably engageable within an interstitial space (26) between platform support members (20) providing an adjustable surface (32) with respect to the rectangular frame (12), wherein the platform (24) has a pair of stop members (38) fixedly attached to a second surface (32b) at outer edges (64a, b) of the platform (24) to prevent sliding movement after full engagement of the platform (24) with respect to the platform support members (20), preventing unintended dislodging movement with respect to the interstitial space (26) between the platform support members (20).

12. The multifunctional cart (10) of claim 11 further comprising:
a pull handle (30) pivotably attached to the rectangular frame (12).

13. The multifunctional cart (10) of claim 11, wherein the platform (24) has a first surface (32a) with a padded area (34) defining a seat (36).

14. The multifunctional cart (10) of claim 11 further comprising:
a tray (42) pivotably attached to the rectangular frame (12) at one of the opposite ends (16), wherein the tray (42) is lockable in both a storage position (78) and an open position (80).

15. The multifunctional cart (10) of claim 11, wherein a first tray (42a) has a recessed first surface (44) and a second tray (42b) is a cup holder (54).

16. The multifunctional cart (10) of claim 11 further comprising:
a plurality of lockable wheels (40) attached to the rectangular frame (12).

17. The multifunctional cart (10) of claim 11, wherein the rectangular frame (12), platform (24), pair of arms (14) and platform support members (22) are composed of a lightweight, non-ferrous material.

18. A multifunctional cart (10) comprising:
a rectangular frame (12) having a pair of short sides (82) and a pair of long sides (84);
a pair of side rails (46) removably attached to the rectangular frame (12) and defining a storage space (48);
a tray (42) pivotably attached to the rectangular frame (12) at one of the opposite ends (16), wherein the tray (42) is lockable in both a storage position (78) and an open position (80), wherein a first tray (42a) has a recessed first surface (44) and a second tray (42b) is a cup holder (52);
a pair of arms (14), each arm (14) fixedly attached at opposite ends (16) of the rectangular frame (12) and extending outwardly from the rectangular frame (12) defining an outer closed end (18);
a plurality of platform support members (20) transversely attached along a longitudinal axis (86) to the rectangular frame (12) at spaced distances (22) outwardly from the rectangular frame (12);
a platform (24) slideably engageable within an interstitial space (26) between platform support members (20) providing an adjustable surface (28) with respect to the rectangular frame (12), wherein the platform (24) has a pair of stop members (38) fixedly attached to a second surface (32b) at outer edges (64a, b) of the platform (24) to prevent sliding movement after full engagement of the platform (24) with respect to the platform support members (20), preventing unintended dislodging movement with respect to the interstitial space (26) between the platform support members (20), and the platform (24) further comprising a first surface (32a) with a padded area (34) defining a seat (36).

19. The multifunctional cart (10) of claim 18 further comprising:
a pull handle (30) pivotably attached to the rectangular frame (12).

20. The multifunctional cart (10) of claim 18 further comprising:
a plurality of lockable wheels (40) attached to the rectangular frame (12).
